(19) United States
(12) Patent Application Publication
(10) Pub. No.: US 2026/0192765 A1
(43) Pub. Date: Jul. 9, 2026

(54) TRAILER HITCH WITH BUMPER PROTECTOR

(71) Applicant: Tim Brake, Fair Grove, MO (US)

(72) Inventor: Tim Brake, Fair Grove, MO (US)

(21) Appl. No.: 19/442,875

(22) Filed: Jan. 7, 2026

Related U.S. Application Data
(60) Provisional application No. 63/742,485, filed on Jan. 7, 2025.

(51) Int. Cl. B60R 19/44; B60D 1/06; B60D 1/52

(52) U.S. Cl. CPC B60R 19/44; B60D 1/06; B60D 1/52

(57) ABSTRACT

A trailer hitch includes a hitch shank having a proximal end sized to fit within a vehicle hitch receiver and a distal end. The hitch includes an angled plate having a substantially horizontal portion and an angularly offset portion fixedly secured to the distal end of the hitch shank. The hitch further includes a hitch ball assembly disposed on the substantially horizontal portion of the angled plate. The hitch ball assembly includes a hitch ball sized to fit within a complementary coupling, a foot plate, and a nut which is tightenable along a thread below the horizontal portion of the angled plate to secure the hitch ball in place. The hitch also includes a substantially vertical plate rigidly attached to and extending upwardly from the hitch shank.

### CROSS REFERENCE TO RELATED APPLICATIONS

This application claims priority to U.S. Provisional Patent Application No. 63/742,485, filed Jan. 7, 2025, the disclosure of which is incorporated herein in its entirety by reference.

### FIELD OF THE DISCLOSURE

The disclosure relates generally to the field of trailer hitches. More specifically, the disclosure relates to a hitch with a rear bumper protector.

### SUMMARY

In an embodiment, a trailer hitch includes a hitch shank having a proximal end sized to fit within a vehicle hitch receiver and a distal end. The hitch includes an angled plate having a substantially horizontal portion and an angularly offset portion fixedly secured to the distal end of the hitch shank. The hitch further includes a hitch ball assembly disposed on the substantially horizontal portion of the angled plate. The hitch ball assembly includes a hitch ball sized to fit within a complementary coupling, a foot plate, and a nut which is tightenable along a thread below the horizontal portion of the angled plate to secure the hitch ball in place. The hitch also includes a substantially vertical plate rigidly attached to and extending upwardly from the hitch shank.

### BRIEF DESCRIPTION OF THE DRAWINGS

Illustrative embodiments of the present disclosure are described in detail below with reference to the attached drawing figures.

FIG. 1 is a front perspective view of the hitch having a bumper protector.

FIG. 2 is a side view of the hitch of FIG. 1.

FIG. 3 is a top view of the hitch of FIG. 1.

FIG. 4 is a front view of the hitch of FIG. 1 installed on a pickup truck.

### DETAILED DESCRIPTION

Trailer hitches are generally known in the art and are typically employed in personal or professional applications when a user desires to tow a vehicle or trailer behind a towing vehicle 10. Typically, the hitch is installed on the towing vehicle 10 before the towed vehicle or trailer is coupled to the hitch by a coupler, such as a hitch ball mount. To couple the towing vehicle 10 to the towed vehicle or trailer, the user must typically maneuver, usually in reverse, the towing vehicle 10 until the hitch coupler and the corresponding coupler on the trailer are aligned and then may be coupled. Often, it may be difficult for a driver of the towing vehicle to align the hitch coupling to the corresponding coupling, especially without the aid of a second person and/or a camera viewing the hitch itself. This difficulty can result in misalignment of the hitch coupler and the corresponding coupler on the trailer, and in such instances may lead to the trailer coupler striking the rear bumper 12 or another element of the towing vehicle 10, causing damage. The present disclosure relates to a trailer hitch which provides the towing vehicle 10 with additional protection against unwanted damage, including but not limited to damage which may occur from a misaligned trailer coupler striking the towing vehicle 10.

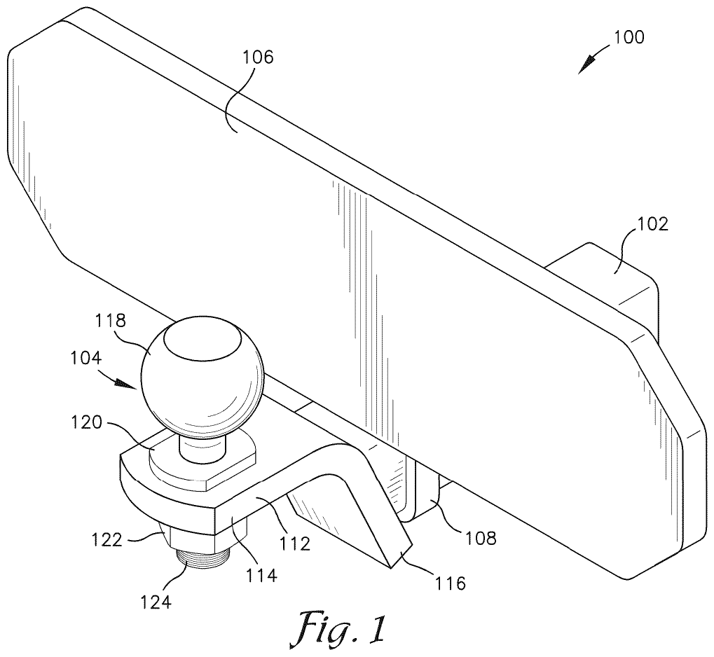

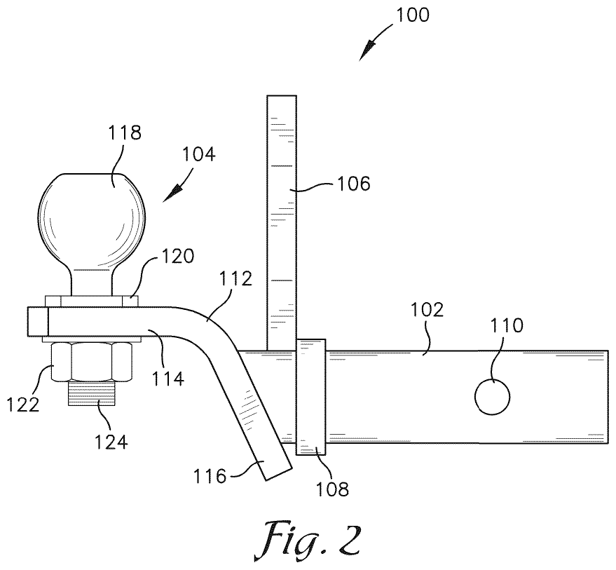

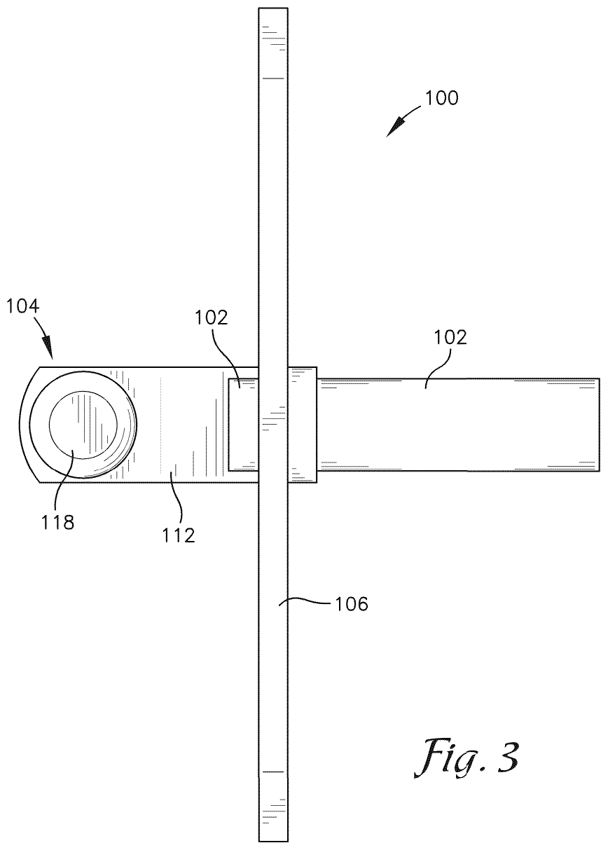

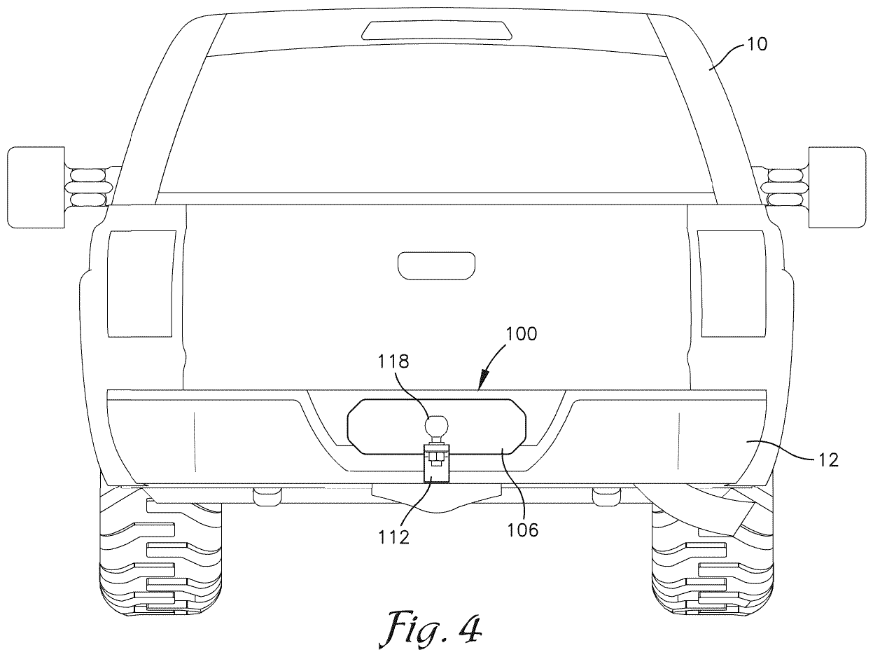

FIGS. 1-4 depict an embodiment of a trailer hitch 100 suitable for attachment to a hitch receiver located on a towing vehicle 10. The trailer hitch 100 includes a hitch shank 102, a hitch ball assembly 104, and a protective plate 106. The hitch shank 102 is sized to fit within a typical vehicle hitch receiver, and includes a stop 108 which limits the insertion of the shank 102 to a desired depth within the hitch receiver. The shank 102 may also include a hole 110 extending substantially horizontally therethrough, the hole 110 being sized to receive a locking pin to restrict movement of the hitch shank 102 within the hitch receiver. A proximal end of the hitch shank 102 extends into the hitch receiver, and a distal end of the hitch shank 102 is connected to the hitch ball assembly via an angled plate 112. The angled plate 112 has a substantially horizontal portion 114 containing the hitch ball assembly 104 and an angularly offset portion 116 fixedly mounted (e.g., by a fastener or, preferably, welded) to the distal end of the hitch shank 102. The horizontal portion 114 and the angularly offset portion 116 are connected by a radius 118.

The hitch ball assembly 104, alternately referred to as a hitch coupling, includes a hitch ball 118 is sized to fit within a complementary coupling disposed on a trailer or other towable vehicle. The hitch ball 118 is secured to the angled plate 112 by a foot plate 120 and is secured in place by a nut 122 which is tightened along thread 124 below the horizontal portion 114 of the angled plate 112.

The protective plate 106 is generally vertical (i.e., extending perpendicular to the hitch shank 102), extending upwardly from the hitch shank 102. The protective plate 016 is fixedly secured (e.g., by fasteners or, more preferably, welded) to the hitch shank. The protective plate 106 extends outward from the hitch shank 102, preferably such that the protective plate 106 is generally parallel to a rear bumper of the towing vehicle 10. In the illustrated embodiment, the protective plate abuts the stop 108, and is disposed between the stop 108 and the distal end of the hitch shank 102. One of skill in the art will appreciate that in other embodiments the protective plate 106 may be axially offset from the stop 108.

The protective plate 106 as shown is octagonal in shape but has a generally rectangular profile, although one of skill in the art will appreciate that the protective plate 106 may be any number of shapes, including but not limited to rectangular, trapezoidal, elliptical, V-shaped, U-shaped, and generally polygonal. In some embodiments, the protective plate 106 may be formed such that obfuscation of the license plate of the towing vehicle 10 is minimized. The protective plate 106 is preferably formed from steel, as the rest of hitch 100 may be, and may be solid or, in some embodiments, may include an aesthetic design which may be engraved or embossed thereon, or may be cut therein by plasma, laser, waterjet, or other methods now known or later developed. The protective plate 106 can be made from a variety of materials other than steel, such as aluminum, plastic or carbon fiber.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A trailer hitch, comprising:
a hitch shank having a proximal end sized to fit within a vehicle hitch receiver and a distal end;
an angled plate having a substantially horizontal portion and an angularly offset portion fixedly secured to the distal end of the hitch shank;
a hitch ball assembly disposed on the substantially horizontal portion of the angled plate, the hitch ball assembly comprising:
a hitch ball sized to fit within a complementary coupling;
a foot plate; and
a nut which is tightenable along a thread below the horizontal portion of the angled plate to secure the hitch ball in place;
a substantially vertical plate rigidly attached to and extending upwardly from the hitch shank.

2. The trailer hitch according to claim 1, further comprising a stop disposed along the hitch shank, and wherein the substantially vertical plate is disposed between the stop and the distal end of the hitch shank.

3. The trailer hitch according to claim 1, wherein the substantially vertical plate abuts the stop.

4. The trailer hitch according to claim 1, wherein the substantially vertical plate is formed from a material selected from the group consisting of steel, aluminum, plastic and carbon-fiber.

5. The trailer hitch according to claim 1 has a shape selected from a group consisting of: rectangular, trapezoidal, elliptical, V-shaped and U-shaped.
